(19) United States
(12) Patent Application Publication
(10) Pub. No.: US 2006/0273276 A1
(43) Pub. Date: Dec. 7, 2006

(54) Quick coupling unit with integrated check valve

(75) Inventors: Erminio Moretti, Grenoble (FR); Franck Lallement, Les Marches (FR); Albert Raymond, Claix (FR)

Correspondence Address: BAKER & DANIELS LLP;111 E. WAYNE STREET, SUITE 800, FORT WAYNE, IN, 46802, US

(73) Assignee: A. RAYMOND & CIE, Grenoble (FR)

(21) Appl. No.: 10/558,178

(22) PCT Filed: May 13, 2004
(86) PCT No.: PCT/EP04/05117

§ 371 Date: Jul. 21, 2006

(30) Foreign Application Priority Data
May 28, 2003 (DE) 103 24 307.0

(51) Int. Cl. F16K 51/00

(52) U.S. Cl. 251/149.6

(57) ABSTRACT

Proposed is a quick coupling unit (1) for lines conducting flowable or pourable media, in which a check valve (5) is integrated for controlling the pressure of the medium or for venting the lines conducting the medium. Said check valve (5) is arranged in an auxiliary branch (4) that comes off the main line of the quick coupling unit (1) and is open to the outside, and its valve body (10) is moved against a restoring force from its position blocking the passage of the medium into its position allowing the passage of the medium by means of a valve stem (12) that can be accessed from the outside. The auxiliary branch (4) is at the same time the valve housing (4) of the check valve (5). The valve body (10), which is able to move axially in the valve housing (4), is implemented in one piece and comprises a valve cone (11), the valve seat of which is implemented as a corresponding conical surface (16) on a hollow counterpart (17) sealingly inserted in the open end of the auxiliary branch (4) or valve housing (4) against the inner wall thereof. The check valve (5) has the advantage of consisting of only a few individual parts that are simple and inexpensive to produce and assemble and are preferably made of plastic. Extreme tightness is achieved when the valve is closed (FIG. 1).

### BACKGROUND OF THE INVENTION

The invention relates to a quick coupling unit for lines conducting flowable or pourable media, comprising an integrated check valve for controlling the pressure of the medium or for venting the lines conducting the medium, in which the check valve is arranged in an auxiliary branch that comes off the main line of the quick coupling unit and is open to the outside, and its valve body can be moved against a restoring force from its position blocking the passage of the medium into its position allowing the passage of the medium by means of a valve stem that can be accessed from the outside.

European Patent Application EP 1 223 392 A1 describes a valve for filling the cooling line of an air conditioning system with coolant. The valve housing comprises a coupling part by means of which it can be turned aside on the coolant line in the region of a fill opening in such a way that the fill opening covers the discharge opening of the valve. The discharge opening opens behind a setoff in a cavity in the valve housing, which cavity is open to the rear and in which a valve body is displaceable and, at least in the portion thereof directly adjacent the discharge opening, sealingly abuts the wall of said cavity; and further comprises a valve head that is tapered in a conical shape and that sealingly rests or can be made to rest on the edge of a setoff between the discharge opening and the cavity. A connecting bore provided in the valve body places the portion of the cavity surrounding the valve head in communication with the portion open to the rear.

To fill the coolant line with coolant the valve is in an open position, i.e., the conical valve head is lifted off its valve seat or a tool must be used to bring it into that position. Alternatively, it is also proposed to hold the valve body in readiness for the filling process completely outside the valve housing. For the filling operation a special tool is placed on the open end of the valve body, in which there is a cavity that is thereby placed in direct communication with the aforesaid cavity in the valve body and can be connected to a coolant source via a shutoff valve. In addition, a stem is displaceable in the special tool and is actuated, once the filling process has been completed, to displace the valve body and press it sealingly onto its seat. The special tool is then removed. To prevent leaks at the valve seat, a metallic seal is required between the valve seat and the valve body, i.e., both parts must be made of a suitable metal, for example the valve head of brass and the valve seat of steel. To hold the valve head on its seat, the valve body must be brought by its circumferential surface, which is ribbed for this purpose, into a press-fit connection with the inner wall of the valve body. As an additional assurance, it is proposed to deform the valve body, once it has been seated with a firm seal on the valve seat, so that it can no longer be moved out of this closed position.

It is evident from the foregoing alone that this valve is designed for one-time use only. No way is provided to reopen the valve in order to drain coolant or to refill or vent the system. Furthermore, the special tool needed is quite complex and expensive. The requirement that there be a metallic seal between the valve body and the valve seat increases the cost of production, which is already a weighty factor due to the one-time usability of the device.

U.S. Pat. No. 5,711,508 discloses a quick coupling unit that is T-shaped. The liquid medium flows through the branch formed by the leg of the T and exits the unit through the one branch of the crossbar of the T coming off at a right angle. At the intersection of the leg and the crossbar of the T, this connection can be interrupted by a valve body that is biased by a spring toward its valve seat and can be brought into and held, against the force of the spring, in an open position that allows the medium to pass through by means of a stem displaceable inside the leg of the T. Disposed in the other branch of the crossbar of the T is a nonreturn or check valve intended to allow the pressure of the medium within the system to be monitored continuously and during operation by means of a measuring device that can be connected to the end of said branch.

Said valve is screwed into said branch of the T crossbar from the open end. A Teflon seal between the outer wall of the valve housing and the inner wall of the T crossbar results in the formation of an outer chamber and an inner chamber, the latter being in direct communication with the medium-conducting branch of the T crossbar, in which the same pressure therefore prevails as in the rest of the medium-conducting system. Inside the substantially hollow-cylindrical valve body, a valve stem is displaceable against the force of a return spring that carries at its end a deformable gasket, which when the return spring is relaxed rests on the annular surface of the valve housing as a valve seat and can be lifted off this seat against the force of the return spring. If the gasket is lifted off its seat, the inner and the outer chamber are placed in communication and the pressure in the system can therefore be monitored during operation by means of a measuring device connected to the outer chamber.

For it to be operational, the valve is composed of a great many individual parts—not all of which are mentioned here,—which increase the cost and complexity of production and installation. The achievable tightness of the valve may well be adequate for the described purpose, but a truly reliable, absolutely leak-free shutoff cannot be obtained in any lasting fashion with the deformable gasket resting on an annular surface of the valve housing.

### SUMMARY OF THE INVENTION

The object of the invention is to provide a quick coupling unit of the kind described above, comprising, integrated therein, a valve by means of which the pressure within the system can be controlled, particularly lowered as needed, e.g: for necessary maintenance, but which in the closed state ensures utmost tightness that is effectively leak-free. Said unit is also intended to be easy to construct and operate and inexpensive to manufacture.

This is achieved according to the invention in that the auxiliary branch of the quick coupling unit is at the same time the valve housing of the check valve, and the valve body, which is able to move axially in the valve housing, is implemented in one piece and comprises a valve cone, the valve seat of which is implemented as a corresponding conical surface on a hollow counterpart sealingly inserted in the open end of the auxiliary branch or valve housing against the inner wall thereof. This arrangement is comprised of only a few parts that are simple to manufacture—preferably of plastic—and can be assembled quickly and easily. The conical surfaces on the valve body and the valve seat ensure high tightness for the closed valve.

According to a preferred embodiment, the valve cone transitions at its narrow, outwardly directed end directly into the valve stem and the latter projects into the cavity of a beaker-shaped segment of the counterpart that is open to the outside. In this cavity open to the outside, the valve stem is readily accessible and can be actuated with a simple tool.

The valve stem is preferably cylindrically shaped and is guided along the inner surface of a hollow-cylindrical portion of the counterpart located between its conical surface and its beaker-shaped segment; the valve stem can be provided in its circumferential surface with longitudinal flutes. These longitudinal flutes ensure or improve the passability of the medium when the valve is open.

A cylindrical projection is preferably formed onto the broad, inwardly directed end of the valve cone to guide and center a return spring; said projection forms a step on the valve cone, so that the return spring can bear with its one end against said step and with its other end against an annular surface that projects inwardly from the wall of the auxiliary branch or valve housing. The valve body thus combines into a single, one-piece component of uncomplicated shape the closing body of the valve, the stem for actuating the valve and a part for guiding and centering the return spring. This also makes for simple and inexpensive production and assembly.

The inner wall of the auxiliary branch or valve housing can be provided with longitudinal grooves that also improve the passability of the medium.

The valve cone comprises in its circumference an annular groove for receiving a sealing ring, which when the valve is closed is pressed firmly into the groove and against the conical surface of the valve seat by the return spring and the pressure of the medium, so that high tightness is achieved. This tightness is increased still further if the valve housing and the counterpart are welded or fused together at their contact points. The auxiliary branch of the quick coupling unit or the valve housing formed thereby, the counterpart, and the valve body as a whole can advantageously all be injection-molded or cast of plastic.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of a quick coupling unit with an exploded diagram of the inventive check valve integrated therein for controlling the pressure in the system;

FIG. 2 is a longitudinal section through the check valve; and

FIG. 3 is a cross section through the check valve along line A-A of FIG. 2.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DESCRIPTION OF THE PRESENT INVENTION

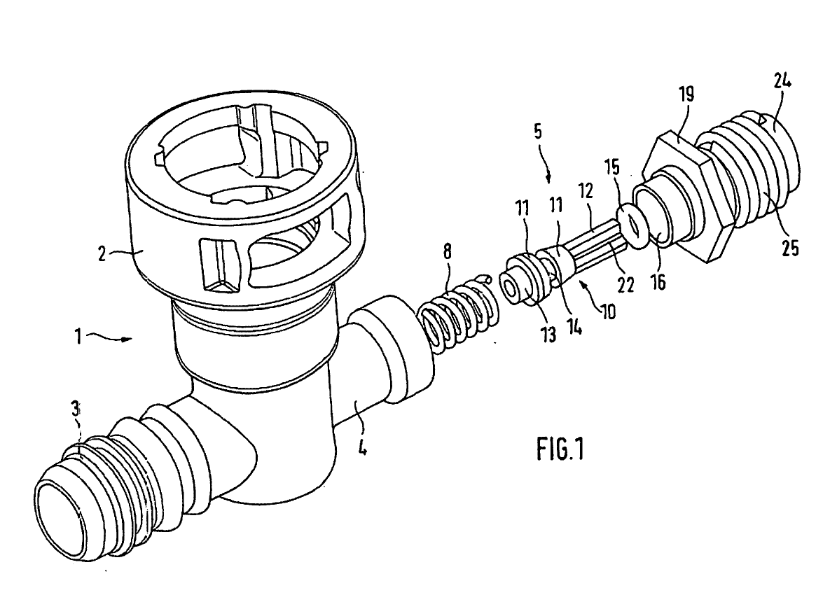

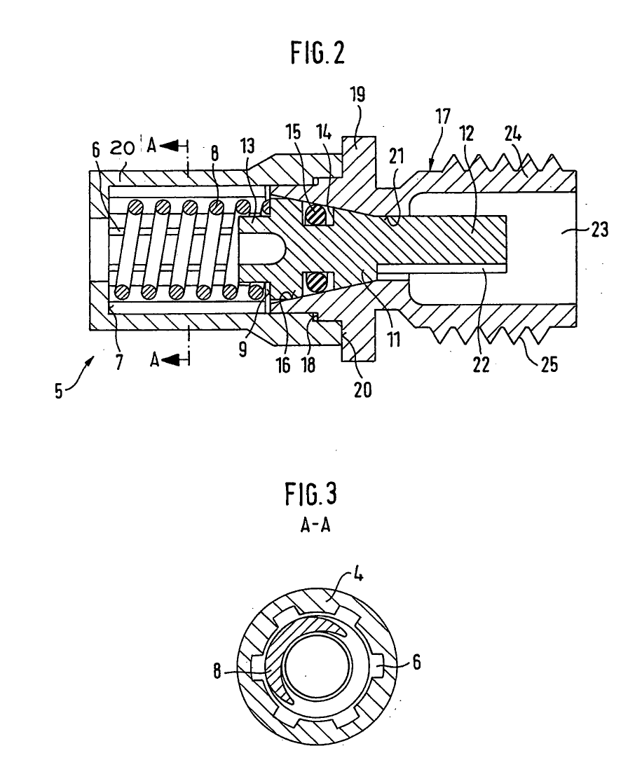

Illustrated in FIG. 1 is a quick coupling unit 1 that is substantially T-shaped. The main connection for the medium is between quick coupling 2 and connecting branch 3 disposed at right angles thereto. Auxiliary branch 4 prolonging connecting branch 3 receives check valve 5, which is illustrated in FIG. 1 in an exploded diagram, in its individual parts, as it were, prior to assembly or installation. It will be described with simultaneous reference to the longitudinal section of FIG. 2. Of the quick coupling unit 1, FIG. 2 shows only auxiliary branch 4 with check valve 5 built thereinto. Auxiliary branch 4 forms a hollow-cylindrical housing 20 whose inner wall is provided with evenly spaced longitudinal grooves 6 (see also FIG. 3) and comprises an inward-directed annular surface 7 at the transition to the portion of the quick coupling unit not shown in FIG. 2.

Return spring 8 bears with its one end against this annular surface 7 and with its other end against a step 9 fashioned on the valve body 10 inserted in housing 4. The longitudinal grooves 6 serve to center the return spring 8 and also provide a passageway for the medium (see below). Valve body 10 is implemented as a valve cone 11, which transitions at its narrower end into an outward-pointing valve stem 12 and on whose broader end is formed a cylindrical prolongation 13 that creates step 9 and at the same time serves to center and guide return spring 8. Valve cone 11 is further provided on its circumferential surface with an annular groove 14 for receiving a sealing ring 15. Valve cone 11 is maintained by return spring 8 in abutment with a corresponding conical surface 16 on which is formed a counterpart 17 comprised of substantially three segments.

The segment that includes conical surface 16 is inserted in the open end of auxiliary branch 4 or the valve housing 20 defined formed by said auxiliary branch, to form the valve seat for valve cone 11. It comprises on its outer surface a setoff 18 and a radial lug 19 by which it rests against a step correspondingly provided in valve housing 20, or rests on the front face 20 of valve housing 20. Following conical surface 16 is a segment comprising a cylindrical inner surface 21 along which valve stem 12 is guided when valve body 10 is moved axially to actuate the valve.

To provide the medium with a passageway when valve body 10 is lifted off conical surface 16, the circumferential surface of valve stem 12 is provided with longitudinal flutes 22. Valve stem 12 extends through the segment comprising cylindrical inner surface 21 and into the outwardly accessible cavity 23 of the third, beaker-shaped segment 24 of counterpart 17. The outer wall of beaker-shaped segment 22 is provided with a thread 25 so that cavity 23 can be sealed from the outside by means of a protective cap (not shown).

To ensure utmost tightness for the arrangement, the parts that do not move relative to one another, namely auxiliary branch 4 or valve housing 20 defined thereby and counterpart 17, are preferably welded or fused together at their contact surfaces after assembly; this is facilitated by the parts preferably being made of a suitable plastic. Valve body 10 is also advantageously cast or injection-molded of plastic in one piece.

In the starting position, valve 5 is closed. Valve cone 11 is held firmly and sealingly in abutment with conical surface 16 both by return spring 8 and by the pressure prevailing in the system, and sealing ring 15 is pressed sealingly into annular groove 14 and against conical surface 16. When the pressure in the system is to be reduced, for example for maintenance work, this can be done in a simple manner by lifting valve cone 11 out of its seat—i.e., conical surface 16 is raised—against the force of return spring 8 by means of a simple tool that grasps valve stem 12, so that medium can escape in metered fashion through auxiliary branch 4 (valve housing 20), abetted by the longitudinal grooves 6 extending in the inner wall, and through opened check valve 5, longitudinal flutes 22 on valve stem 12 and cavity 23 of counterpart 17. Conversely, it would also be possible to build up the pressure in the system in a metered manner.

This check valve 5 integrated into the quick coupling unit is easy and inexpensive to produce, consisting as it does of only a few parts of relatively simple shape, namely valve housing 20 (auxiliary branch 4), valve body 10 with sealing ring 15, counterpart 17 and return spring 8. All these parts except for return spring 8 can advantageously be made of plastic, simplifying and lowering the cost of production and saving on weight. It is easy to actuate, no special tool is needed to do so, repeated actuation poses no problems whatsoever, and it is not an item that has to be discarded after being actuated only once. The conical shape of the sealing body and its abutment surface, the deformable, press-in sealing ring 15, and the welding of valve housing 20 to counterpart 17 at the contact surfaces result in the greatest possible tightness.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-8. (canceled)

9. A quick coupling unit for lines conducting flowable or pourable media, comprising an integrated check valve (5) for controlling the pressure of the medium or for venting the lines conducting the medium, in which the check valve (5) is arranged in an auxiliary branch that comes off the main line of the quick coupling unit (1) and is open to the outside and its valve body (10) can be moved against a restoring force from its position blocking the passage of the medium into its position allowing the passage of the medium by means of a valve stem (12) that can be accessed from the outside, said auxiliary branch at the same time being the valve housing (4) of said check valve (5),
characterized in that said valve body (10), which is able to move axially in said valve housing (4), is implemented in one piece and comprises a valve cone (11), the valve seat of which is implemented as a corresponding conical surface (16) on a hollow counterpart (17) sealingly inserted in the open end of said valve housing (4) against the inner wall thereof, and in that said valve cone (11) comprises in its circumference an annular groove (14) for receiving a sealing ring (15).

10. The quick coupling unit as specified in claim 9, characterized in that said valve cone (11) transitions at its narrow, outwardly directed end into said valve stem (12), which extends into the cavity (23) of a beaker-shaped segment (24) of said counterpart (17) that is open to the outside.

11. The quick coupling unit as specified in claim 10, characterized in that said valve stem (12) is cylindrically shaped and is guided along the inner surface (21) of a hollow-cylindrical segment of said counterpart (17) between its conical surface (16) and its beaker-shaped segment (24), and in that said valve stem (12) is provided in its circumferential surface with longitudinal flutes (22).

12. The quick coupling unit as specified in claim 9, characterized in that formed onto the broad, inwardly directed end of said valve cone (11) is a cylindrical prolongation (13) that serves to guide and center a return spring (8) and by which a step (9) is formed on said valve cone (11), and in that said return spring (8) bears with its one end against said step (9) and with its other end against an annular surface (7) that projects inwardly from the wall of said auxiliary branch or valve housing (4).

13. The quick coupling unit as specified in claim 9, characterized in that the inner wall of said valve housing (4) is provided with longitudinal grooves (6).

14. The quick coupling unit as specified in claim 9, characterized in that said valve housing (4) and said counterpart (17) are welded or fused together at their contact points.

15. The quick coupling unit as specified in claim 9, characterized in that said auxiliary branch or valve housing (4), said counterpart (17), and said valve body (10) are injection-molded or cast of plastic.
